(19) United States
(12) Patent Application Publication
(10) Pub. No.: US 2026/0106940 A1
(43) Pub. Date: Apr. 16, 2026

(54) TEXT CONTROL CENTER FOR SECONDARY PUBLIC SAFETY ANSWERING POINT

(71) Applicant: Intrado Life & Safety, Inc., Longmont, CO (US)

(72) Inventor: Thomas E. Nudo, SR., LONGMONT, CO (US)

(21) Appl. No.: 18/913,908

(22) Filed: Oct. 11, 2024

(51) Int. Cl. H04M 11/04; H04M 11/06

(52) U.S. Cl. CPC H04M 11/04; H04M 11/06

(57) ABSTRACT

A method includes receiving a text control center (TCC) messaging request indicating a position of an alarm; determining a secondary PSAP ID, at least in part based on the position of the alarm; and transmitting a secondary PSAP notification, at least in part based on the secondary PSAP ID. The secondary PSAP notification indicates the position of the alarm.

### BACKGROUND

### Technical Field

This disclosure relates to centralized call answering arrangements using operator intervention for emergency applications and, in particular, to a text control center for a secondary public safety answering point (PSAP).

### Related Art

PSAPs are call centers in which communications for primary or specialized emergency services are received and handled. Primary emergency services can include police, fire, and emergency medical services, for example. Specialized emergency services can include animal control services, police tactical units, and search and rescue, for example.

PSAPs receive a variety of communications. For example, PSAPs can receive telephone calls from a public switched telephone network (PSTN) and/or a mobile network (for example, cellular network). Some PSAPs can additionally or alternatively receive Voice over Internet Protocol (VOIP) calls.

At the urging of governmental entities, PSAPs have begun accepting text messages from a mobile phone or device. To this end, modern PSAPs can receive text messages including Short Message Service (SMS), Multimedia Messaging Service (MMS), Rich Communication Services (RCS), and/or Simple Notification Service (SNS) services.

### BRIEF SUMMARY

In a first implementation of the present disclosure, a method includes receiving a text control center (TCC) messaging request indicating a position of an alarm; determining a secondary PSAP ID, at least in part based on the position of the alarm; and transmitting a secondary PSAP notification, at least in part based on the secondary PSAP ID, the secondary PSAP notification indicating the position of the alarm.

A second implementation is the first implementation, further comprising: determining a primary PSAP ID, at least in part based on the position of the alarm; and transmitting a primary PSAP notification, at least in part based on the primary PSAP ID, the primary PSAP notification indicating the position of the alarm.

A third implementation is the second implementation, further comprising: determining that a secondary PSAP notification acknowledgement was not received within a predetermined duration.

A fourth implementation is any of the first through third implementations, wherein the TCC messaging request indicates an alarm type, and the secondary PSAP ID is obtained, at least in part based on the alarm type.

A fifth implementation is any of the first through fourth implementations, further comprising: receiving a secondary PSAP notification acknowledgement; and transmitting a TCC PSAP notification acknowledgement, at least in part based on a vendor ID, wherein the TCC notification indicates the vendor ID.

A sixth implementation is any of the first through fifth implementations, wherein the secondary PSAP notification indicates a vendor ID and a callback number of the vendor ID.

A seventh implementation is any of the first through sixth implementations, further comprising: receiving a text message from the secondary PSAP, the text message indicating monitoring information, the secondary PSAP notification indicating the monitoring information, and the TCC messaging request indicating the monitoring information; and transmitting at least a portion of the text message, at least in part based on the monitoring information.

In an eighth implementation, a system includes at least one network interface that receives a text control center (TCC) messaging request indicating a position of an alarm; and at least one processor configured to cause the system to at least determine a secondary PSAP ID, at least in part based on the position of the alarm, wherein the at least one network interface transmits a secondary PSAP notification, at least in part based on the secondary PSAP ID, the secondary PSAP notification indicating the position of the alarm.

A ninth implementation is the eighth implementation, wherein the at least one processor is further configured to determine a primary PSAP ID, at least in part based on the position of the alarm, and the at least one network interface transmits a primary PSAP notification, at least in part based on the primary PSAP ID, the primary PSAP notification indicating the position of the alarm.

A tenth implementation is the ninth implementation, wherein the at least one processor is further configured to determine that a secondary PSAP notification acknowledgement was not received within a predetermined duration.

An eleventh implementation is any of the eighth through tenth implementations, wherein the TCC messaging request indicates an alarm type, and the secondary PSAP ID is obtained, at least in part based on the alarm type.

A twelfth implementation is any of the eighth through eleventh implementations, wherein the at least one network interface receives a secondary PSAP notification acknowledgement, the at least one network interface transmits a TCC PSAP notification acknowledgement, at least in part based on a vendor ID, and the TCC notification indicates the vendor ID.

A thirteenth implementation is any of the eighth through twelfth implementations, wherein the secondary PSAP notification indicates a vendor ID and a callback number of the vendor ID.

A fourteenth implementation is any of the eighth through thirteenth implementations, wherein the at least one network interface receives a text message from the secondary PSAP, the text message indicating monitoring information, the secondary PSAP notification indicating the monitoring information, the TCC messaging request indicating the monitoring information, and the at least one network interface transmits at least a portion of the text message, at least in part based on the monitoring information.

In a fifteenth implementation, a computer-readable medium is encoded with a computer program that, when executed by a system including at least one processor, causes the system to perform operations. The operations include receiving a text control center (TCC) messaging request indicating a position of an alarm; determining a secondary PSAP ID, at least in part based on the position of the alarm; and transmitting a secondary PSAP notification, at least in part based on the secondary PSAP ID, the secondary PSAP notification indicating the position of the alarm.

A sixteenth implementation is the fifteenth implementation, the operations further comprising: determining a primary PSAP ID, at least in part based on the position of the alarm; and transmitting a primary PSAP notification, at least in part based on the primary PSAP ID, the primary PSAP notification indicating the position of the alarm.

A seventeenth implementation is the sixteenth implementation, the operations further comprising: determining that a secondary PSAP notification acknowledgement was not received within a predetermined duration.

An eighteenth implementation is any of the fifteenth through seventeenth implementations, wherein the TCC messaging request indicates an alarm type, and the secondary PSAP ID is obtained, at least in part based on the alarm type.

A nineteenth implementation is any of the fifteenth through eighteenth implementations, the operations further comprising: receiving a secondary PSAP notification acknowledgement; and transmitting a TCC PSAP notification acknowledgement, at least in part based on a vendor ID, wherein the TCC notification indicates the vendor ID.

A twentieth implementation is any of the fifteenth through nineteenth implementations, wherein the secondary PSAP notification indicates a vendor ID and a callback number of the vendor ID.

A twenty-first implementation is any of the fifteenth through twentieth implementations, the operations further comprising: receiving a text message from the secondary PSAP, the text message indicating monitoring information, the secondary PSAP notification indicating the monitoring information, the TCC messaging request indicating the monitoring information; and transmitting at least a portion of the text message, at least in part based on the monitoring information.

In a twenty-second implementation, a system includes communication means for receiving a text control center (TCC) messaging request indicating a position of an alarm; and processing means for determining a secondary PSAP ID, at least in part based on the position of the alarm, wherein the communication means transmit a secondary PSAP notification, at least in part based on the secondary PSAP ID, the secondary PSAP notification indicating the position of the alarm.

A twenty-third implementation is the twenty-second implementation, wherein the processing means determine a primary PSAP ID, at least in part based on the position of the alarm, and the communication means transmit a primary PSAP notification, at least in part based on the primary PSAP ID, the primary PSAP notification indicating the position of the alarm.

A twenty-fourth implementation is the twenty-third implementation, wherein the processing means determine that a secondary PSAP notification acknowledgement was not received within a predetermined duration.

A twenty-fifth implementation is any of the twenty-second through twenty-fourth implementations, wherein the TCC messaging request indicates an alarm type, and the secondary PSAP ID is obtained, at least in part based on the alarm type.

A twenty-sixth implementation is any of the twenty-second through twenty-fifth implementations, wherein the communication means receive a secondary PSAP notification acknowledgement, the communication means transmit a TCC PSAP notification acknowledgement, at least in part based on a vendor ID, and the TCC notification indicates the vendor ID.

A twenty-seventh implementation is any of the twenty-second through twenty-sixth implementations, wherein the secondary PSAP notification indicates a vendor ID and a callback number of the vendor ID.

A twenty-eighth implementation is any of the twenty-second through twenty-seventh implementations, wherein the communication means receive a text message from the secondary PSAP, the text message indicating monitoring information, the secondary PSAP notification indicating the monitoring information, and the TCC messaging request indicating the monitoring information, and the communication means transmit at least a portion of the text message, at least in part based on the monitoring information.

### BRIEF DESCRIPTION OF THE SEVERAL VIEWS OF THE DRAWINGS

FIG. 1 illustrates an example of a system including a text control center (TCC) for a secondary PSAP, according to an implementation of the present disclosure.

FIG. 2 illustrates an example of a system including a conventional text control center.

FIG. 3 illustrates an example of a system including a text control center, according to an implementation of the present disclosure.

FIG. 4A and FIG. 4B illustrate an example signal flow for a system, according to an implementation of the present disclosure.

FIG. 5 illustrates an algorithm for a text control center, according to an implementation of the present disclosure.

FIG. 6 illustrates a screenshot of an alarm received by a PSAP, according to an implementation of the present disclosure.

FIG. 7 illustrates an algorithm for communicating messages between an IoT service provider and a secondary PSAP via a text control center, according to an implementation of the present disclosure.

FIG. 8 illustrates a computing device, according to an implementation of the present disclosure.

### DETAILED DESCRIPTION

The following foundational information forms a basis from which aspects of the present disclosure can be explained. Such information is offered for purposes of explanation only and, accordingly, should not be construed to limit the scope of the present disclosure, its potential applications, nor the claims.

Conventionally, PSAPs are organized into a hierarchical system including primary PSAPs and secondary PSAPs. Generally, primary PSAPs serve larger, metropolitan areas and, as such, might receive a significant number of emergency calls, even during off-hours. As such, primary PSAPs are often more reliable, because they are more likely to have increased staffing available around-the-clock, heightened redundancy in telecommunications and information technology, and so on.

In contrast, secondary PSAPs generally serve smaller, comparatively more rural, areas. Thus, the population densities of areas served by secondary PSAPs might be lower, and the areas might be less busy during off-hours. Thus, secondary PSAPs might limit staff availability during off-hours.

For example, Orange County in Florida has a population of about 1.5 million people and is served by a primary PSAP. A person might dial 911 from Apopka, a city in Orange County with a population of about 50,000. In this situation, regardless of whether the call is made from a landline or a mobile phone, the call is routed to the Orange County primary PSAP. Once the location of the call is established (e.g., based on address validation) as being in Apopka, the primary PSAP can transfer the call to an appropriate secondary PSAP. In this example, the secondary PSAP is in Apopka.

Similarly, in the case of a text-to-911 message, the initial text message can be routed to a primary PSAP. Once the location of the message is established (e.g., by triangulation or by asking the sender their location), the text message can be transferred to the appropriate secondary PSAP, assuming the secondary PSAP has text-to-911 capabilities.

Conventionally, an Internet of Things (IOT) device, such as a home alarm, can be monitored by an IOT service provider. One example of such an IOT service provider is Vivint Smart Home, Inc. of Provo, UT.

Recently, there has been a demand to integrate Internet of Things (IOT) service providers into the emergency communication ecosystem.

To potentially address these issues and others, various implementations of the present disclosure can implement a text control center for a secondary PSAP, as described herein.

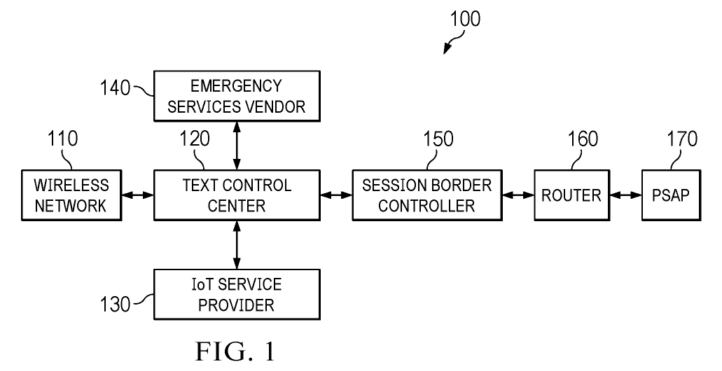

FIG. 1 illustrates an example of a system 100 that includes a text control center (TCC) for a secondary PSAP, according to an implementation of the present disclosure.

When planning emergency services, it is not known what communication capabilities will be available or convenient at the time of an emergency. Thus, it is desirable to accept reports of the emergency in various ways. To that end, the system 100 includes a wireless network 110, a text control center (TCC) 120, an IoT service provider 130, an emergency services vendor 140, a session border controller (SBC) 150, a router 160, and a PSAP 170.

These days, when an emergency occurs, a person will typically use their smartphone to call or send a text message to 911. In this case, the smartphone transmits a signal that is received by a cellular tower. The cellular tower serves as an endpoint of the wireless network 110.

The wireless network 110 can transmit and/or receive a call or a text message communicated to/from the smartphone. In several implementations, the wireless network 110 interfaces between the wireless signals of the smartphone and a wired telecommunication line. However, in some implementations, the wireless network 110 operates exclusively wirelessly. The wireless network 110 can be operated entirely or in part by an operator such as Verizon Communication Inc., AT&T Inc., or T-Mobile US Inc.

According to regulations of the Federal Communications Commission (FCC), the wireless network 110 performs specialized processing of text messages transmitted to 911. In particular, the wireless network 110 can transmit these text messages to the TCC 120.

The TCC 120 can perform routing of the text messages to an appropriate PSAP. For example, if the TCC 120 has location information for a communication (such as the text message), then the TCC 120 can transmit a query to the emergency services vendor 140. The TCC 120 then receives an identification of the PSAP 170 from the emergency services vendor 140. The TCC 120 can then transmit the identification of the PSAP 170, as well as the communication itself, to the session border controller 150.

The emergency services vendor 140 identifies a database of information that associates locations with PSAPs. Such a database is maintained by Intrado Life & Safety Inc. of Longmont, CO, for example. The database can determine a particular PSAP that serves a particular longitude and latitude, for example. In select implementations, the database can determine the PSAP based on a different geocode system, such as what3words.

Further, a particular PSAP might lack dispatch capabilities for a particular emergency service, such as fire rescue. Accordingly, in select implementations, if the emergency services vendor 140 receives an identification of a particular emergency type, then the emergency services vendor 140 can additionally determine a PSAP that provides dispatch capabilities for the particular emergency type.

The emergency services vendor 140 can then transmit the particular PSAP to the TCC 120.

The SBC 150 is a device that can protect and regulate communications transmitted to and received from the router 160 and the PSAP 170. The SBC 150 can regulate Internet Protocol (IP) video, Voice over IP (VoIP) calls, text communications, and chat functions. For example, the SBC 150 can protect the router 160 from Denial of Service (DoS) and Distributed Denial of Service (DDoS) attacks. Further, the SBC 150 can provide encryption services and normalize Session Initiation Protocol (SIP) messages. In several implementations, the SBC 150 is optional.

In the context of system 100, the SBC 150 receives the identification of the PSAP 170 and the communication from the TCC 120. The SBC 150 then forwards at least the communication to the router 160.

The router 160 receives the communication from the SBC 150 or, in implementations without the SBC 150, from the TCC 120. In some implementations, the router also receives the identification of the PSAP 170 from the SBC 150 or the TCC 120. The router 160 then routes the communication to the PSAP 170. In many implementations, the router routes the communication, at least in part based on the received identification of the PSAP 170.

The router 160 also can receive communications from the PSAP 170. In such a situation, the router 160 can transmit such a communication to the SBC 150 or, in an implementation without the SBC 150, to the TCC 120.

Thus, the SBC 150 and/or the TCC 120 additionally can route such a communication to the wireless network 110 or the IoT service provider 130.

The PSAP 170 is a call center that receives emergency communications. In many implementations, a calltaker at the call center receives an emergency communication and determines whether emergency services should be dispatched, what emergency services should be dispatched, and to what location those emergency services should be dispatched. Calltakers answer telephone calls, as well as receive and, in some implementations, send text messages. Calltakers can also transfer calls to non-emergency (e.g., administrative) telephone lines.

The IoT (Internet of Things) service provider 130 provides services interacting with electronic devices. For example, an event might occur without a person being present to assess whether the event is an emergency and to make an emergency call. An example of such an event is a burglary at a person’s home while they are away on vacation. In such a situation, a home alarm device can detect the event and contact the IoT service provider 130.

Frequently, detected events do not reflect emergencies, because of some excusable cause, such as a person inadvertently triggering their own alarm. Other times, an individual IoT device or a system including IoT devices has a malfunction, leading to one or many devices reporting that an event is an emergency.

It is estimated that more than 90% of such detections are not actually emergency events. Accordingly, because there are billions of IoT devices in the United States alone, such detections can easily overwhelm a PSAP. Therefore, the IoT service provider 130 monitors the IoT devices to filter out these false detections.

An example of such an IoT service provider 130 is ADT Inc. of Boca Raton, FL. ADT Inc. provides monitoring services relating to residential and commercial security and fire protection.

The IoT service provider 130 registers the IoT device prior to providing the monitoring service. This registration can include a location (e.g., civic address; longitude and latitude; what3words) at which the IoT device is installed. The registration can also include a telephone number to contact a party responsible for locally monitoring the IoT device, such as a homeowner or a security guard.

In a conventional example, the IoT service provider 130 receives a notification from an IoT device. Then, the IoT service provider 130 can call the party responsible for monitoring the IoT device and ask about the situation at the address. If the party confirms there is an emergency or if the IoT service provider 130 is unable to communicate with the party for a predetermined period of time (e.g., one minute), then the IoT service provider can call the PSAP 170 to report the emergency.

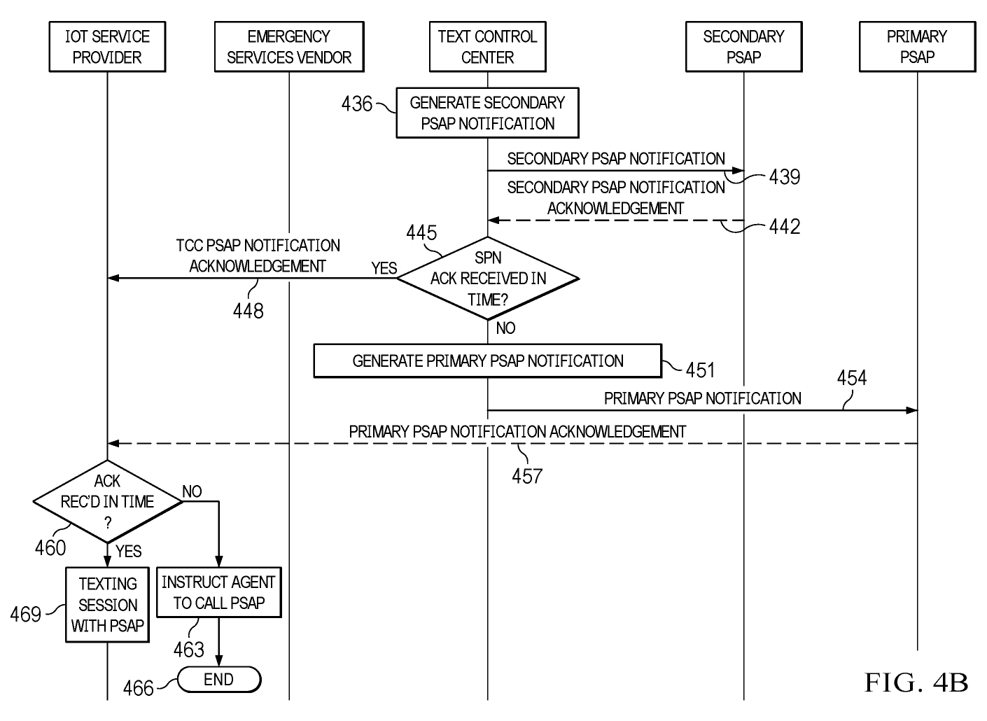

In the context of FIG. 1, the IoT service provider 130 instead sends a messaging request to the TCC 120. The messaging request can be a text message and/or can comply with other data formats, such as Extensible Markup Language (XML) or JavaScript Object Notation (JSON). The messaging request can include or indicate the location at which the IoT device is installed, based on the previous registration of the device. The TCC 120 can then process the messaging request as discussed below in more detail in connection with FIGS. 4-5 and 7.

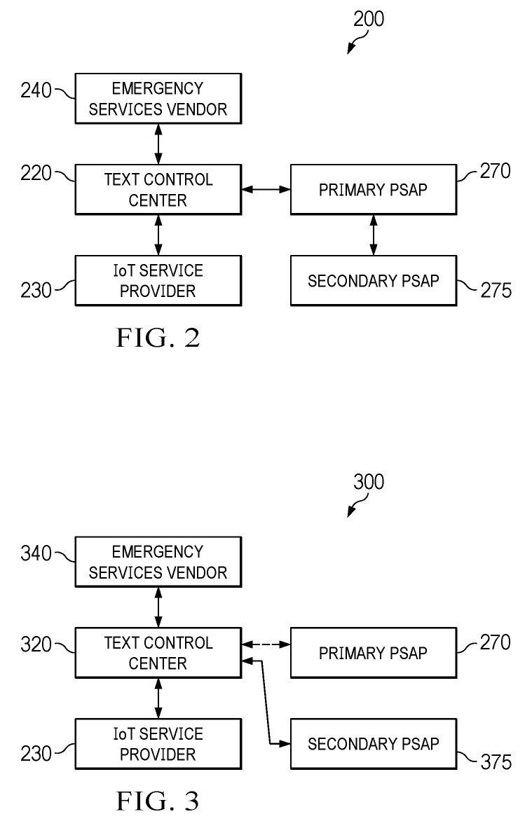

FIG. 2 illustrates an example of a system 200 including a conventional text control center. The system 200 includes a TCC 220, an IoT service provider 230, an emergency services vendor 240, a primary PSAP 270, and a secondary PSAP 275. The TCC 220 is similar to the TCC 120, the IoT service provider 230 is similar to the IoT service provider 130, and the emergency services vendor 240 is similar to the emergency services vendor 140. Further, the primary PSAP 270 is similar to the PSAP 170.

In the system 200, the IoT service provider 230 transmits a messaging request to the TCC 220. The TCC text messaging request can include details about an event, as well as the location to which an IoT device was registered. This location can be a civic address, longitude and latitude, or what3words, for example.

The TCC 220 can then transmit a PSAP request to the emergency services vendor 240, where the PSAP request includes the location information. The emergency services vendor 240 can determine a primary PSAP with jurisdiction over the location identified in the location information. Further, the emergency services vendor 240 can determine whether the primary PSAP has text capabilities. The emergency services vendor 240 can query a database based on the location information and retrieve the identity of the primary PSAP, for example. The emergency services vendor 240 can transmit a PSAP response including the identity to the TCC 220.

The TCC 220 can then transmit a notification to the primary PSAP 270, at least in part based on the identity of the primary PSAP 270. The TCC 220 can also begin a timer when the TCC 220 transmits the notification. Accordingly, the TCC 220 can determine whether an acknowledgement is received from the primary PSAP 270 within a predetermined duration.

The primary PSAP 270 receives the notification. A calltaker can conduct initial processing of the notification. In addition, the primary PSAP 270 can transmit an acknowledgement to the TCC 220, when the calltaker begins initial processing of the notification.

In the initial processing, the calltaker can determine whether the location of the emergency is serviced by a secondary PSAP 275, for example. In addition, the calltaker can ensure the secondary PSAP 275 is available for dispatch services (e.g., because it is not after operating hours of the secondary PSAP 275) or is capable of appropriate dispatch services for the type of emergency. If the calltaker determines that a secondary PSAP 275 services the location, is currently available for dispatch services, and is capable of appropriate dispatch services, then the calltaker can transfer the notification to the secondary PSAP 275.

The secondary PSAP 275 then receives the notification from the primary PSAP 270. The secondary PSAP 275 can then dispatch appropriate services to the location indicated in the notification.

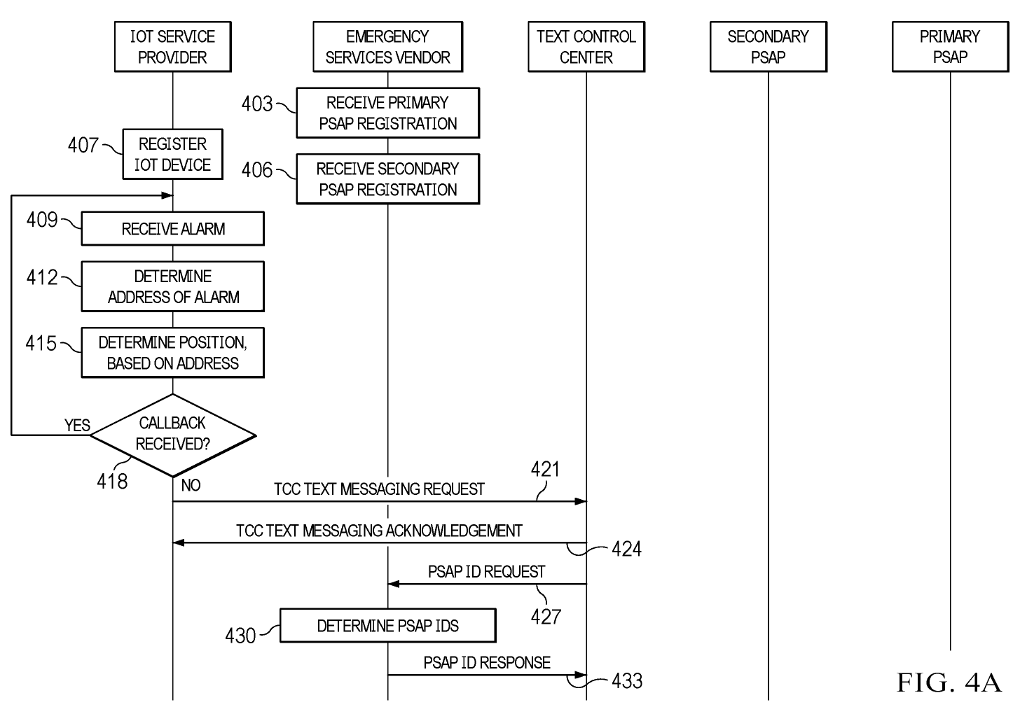

FIG. 3 illustrates an example of a system 300 including a TCC 320 for communicating with a secondary PSAP 375, according to an implementation of the present disclosure. The system 300 includes the IoT service provider 230 and the primary PSAP 270. In addition, the system 300 includes a TCC 320, an emergency services vendor 340, and a secondary PSAP 375.

In the system 300, the emergency services vendor 340 has registered the secondary PSAP 375 in addition to the primary PSAP 270. Thus, the emergency services vendor 340 can determine both the secondary PSAP 375 that has jurisdiction over the location identified in the location information, as well as the primary PSAP 270. Accordingly, the PSAP response transmitted by the emergency services vendor 340 can include or indicate the identities of both the secondary PSAP 375 and the primary PSAP 270.

Accordingly, the TCC 320 can transmit the notification to the secondary PSAP 375, at least in part based on the identity of the secondary PSAP 375.

The secondary PSAP 375 can then conduct processing of the notification and dispatch appropriate services to the location indicated in the notification.

In some situations, the secondary PSAP 375 might be unable to dispatch appropriate services to the location. For example, the secondary PSAP 375 might receive the notification outside of operating hours of the secondary PSAP 375. Alternatively, the secondary PSAP 375 might receive the notification at a time at which the secondary PSAP 375 has reached or exceeded its capacity to handle notifications. In such a situation, the secondary PSAP 375 might not be expected to acknowledge receipt of the notification.

Thus, if the TCC 320 determines that it has not received an acknowledgement from the secondary PSAP 375 within a predetermined duration, the TCC 320 can transmit the notification to the primary PSAP 270, at least in part based on the identify of the primary PSAP 270.

Further, the secondary PSAP 375 might be unable to dispatch appropriate emergency services to the location. For example, the secondary PSAP 375 might not have jurisdiction over appropriate emergency services, such as a fire emergency. Alternatively, the secondary PSAP 375 might have limited ability to dispatch particular emergency services, such as a limited number of fire engines. In such a situation, the secondary PSAP 275 can transfer the notification to the primary PSAP 270.

FIG. 4 illustrates an example signal flow for a system including a TCC for communicating with a secondary PSAP, according to an implementation of the present disclosure.

The signal flow begins at 403 at which the emergency services vendor receives a primary PSAP registration. The primary PSAP registration can include contact information for the primary PSAP, such as a telephone number, a facsimile number, an administrative telephone number, an IP address, and so on. The primary PSAP registration can also include a geographic area of service. This area can be defined in any manner, such as civic addresses, longitudes and latitudes, what3words, political or geographic boundaries, and so on. In various implementations, the primary PSAP registration can include identifications of one or more emergency services. In particular implementations, each of these emergency services can be registered to portions of the geographic area of service. Thus, for example, the primary PSAP can be registered as associated with police service over the entire geographic area of service and with fire service over only a portion of the geographic area of service.

In various implementations, the registration can include a separate identifier of the primary PSAP, although some implementations can use the IP address as the identifier, for example.

In 406, the emergency services vendor receives a secondary PSAP registration. The secondary PSAP registration can include contact information for the secondary PSAP, such as a telephone number, a facsimile number, an administrative telephone number, an IP address, and so on. The secondary PSAP registration can also include a geographic area of service. This area can be defined in any manner, such as civic addresses, longitudes and latitudes, what3words, political or geographic boundaries, and so on. In various implementations, the secondary PSAP registration can include identifications of one or more emergency services. In particular implementations, each of these emergency services can be registered to portions of the geographic area of service. Thus, for example, the secondary PSAP can be registered as associated with police service over the entire geographic area of service and with fire service over only a portion of the geographic area of service.

In various implementations, the registration can include a separate identifier of the secondary PSAP, although some implementations can use the IP address of the secondary PSAP as the identifier, for example.

In addition, the secondary PSAP registration can optionally include an identification of a primary PSAP.

In 407, the IoT service provider performs a registration of an IoT device. For example, the registration can include an address at which the IoT device is installed, as well as a telephone number.

The operations at 403, 406, and 407 can be performed at any time and in any order.

The signal flow begins in detail at 409, in which the IoT service provider receives an alarm from the IoT device. The alarm is a message that includes at least an identifier of the alarm. In many implementations, the alarm identifies a type of alarm, as well. The type can be, for example, “burglary,” “fire,” or “medical.” The signal flow then advances to 412.

In 412, the IoT service provider can determine an address of the alarm, at least in part based on the identifier of the alarm and the registration performed at 407. The signal flow then advances to 415.

In 415, the IoT service provider can determine a position of the alarm, at least in part based on the address. The IoT service provider can determine the position based on premise address validation performed using Google Maps, Apple Maps, and MapQuest, for example. The signal flow then advances to 418.

In some implementations, the IoT service provider can determine the position, at least in part based on the identifier of the alarm and the registration performed at 407. For example, the IoT service provider might not separately determine the address of the alarm before determining the position based on the address. The signal flow then advances to 418.

In 418, the IoT service provider determines whether a callback was received. For example, the IoT service provider commonly has a service agreement with the beneficiary of the IoT device. According to the service agreement, if the IoT device triggers, the person monitoring the IoT device will call the service provider, at least if there is no emergency. In this way, the IoT service provider can avoid the common situation in which the IoT device triggers in a non-emergency situation. If the IoT service provider determines that a callback was received in 418, then the system flow returns to 409.

If the person monitoring the IoT device does not call, then caution dictates that the IoT service provider treat the situation as an emergency. Thus, if the IoT service provider determines that a callback was not received in 418, then the signal flow advances to 421.

In 421, the IoT service provider transmits a TCC text messaging request that is received by the TCC. The TCC text messaging request can include, for example, the position of the alarm. In some implementations, the TCC text messaging request can include or indicate a type of the alarm, such as “fire” or “police.” In addition, the TCC text messaging request can include or indicate a time of the alarm, an address of the alarm, a name of the beneficiary, and/or a permit and/or license number. The TCC text messaging request can also include or indicate an alarm level, an event description, and/or a zone in which the IoT device is installed. The TCC text messaging request can further include or indicate an indication whether the alarm is audible and/or an identifier of the event (e.g., an alarm incident number). The TCC text messaging request additionally can include or indicate the IoT service provider (e.g., a name of the IoT service provider), an operator at the IoT service provider handling the event, and a callback number (CBN) of the IoT service provider. Further, the IoT service provider can begin a timer in 421. The signal flow then advances to 424.

In 424, the TCC can transmit a TCC text messaging acknowledgement back to the service provider. The TCC text messaging acknowledgement can include a session ID for a communication session, as well as status information. The signal flow then advances to 427.

In 427, the TCC can transmit a PSAP ID request to the emergency services vendor. The PSAP ID request can include or indicate the position and/or address of the event. In some implementations, the PSAP ID request can include or indicate a type of the event, such as “burglary” or “fire.” In some implementations, the TCC transmits the PSAP ID request via HTTP-Enabled Location Delivery (HELD). The signal flow then advances to 430.

In 430, the emergency services vendor can determine a text-enabled PSAP that has dispatch capabilities for the position and/or address of the PSAP ID request. In particular, the emergency services vendor can determine an ID of a secondary PSAP, as well as an ID of a primary PSAP. The IDs of the PSAPs can be, include, or indicate IP addresses or telephone numbers of the respective PSAPs, for example. The signal flow then advances to 433.

In 433, the emergency services vendor transmits a PSAP ID response to the TCC. The PSAP ID response can include the ID of the secondary PSAP and the ID of the primary PSAP. In several implementations, the PSAP ID response distinguishes the ID of the secondary PSAP from the ID of the primary PSAP. For example, the PSAP ID response can follow a data structure in which a first field is reserved for the primary PSAP, and a second field is reserved for the secondary PSAP. As another example, the PSAP ID response can include text labels such as “primary PSAP” or “secondary PSAP” to indicate which ID is for which PSAP. The signal flow then advances to 436 in FIG. 4B.

In 436, the TCC generates a secondary PSAP notification, at least in part based on the TCC text messaging request. For example, the secondary PSAP notification can include or indicate all or some of the information in the TCC text messaging request, such as the address and the CBN. The secondary PSAP notification can indicate or include the secondary PSAP ID. The signal flow then advances to 439.

In 439, the TCC can transmit the secondary PSAP notification to the secondary PSAP, which receives the secondary PSAP notification. The TCC can also begin a timer. The signal flow then advances to 442.

If a workstation at the secondary PSAP answers the call, the secondary PSAP can transmit in 442 a secondary PSAP notification acknowledgement to the TCC. The secondary PSAP notification acknowledgement can indicate or include the alarm incident number, for example. The signal flow then advances to 445.

In 445, the TCC can determine whether it received a secondary PSAP notification acknowledgement within a predetermined duration (e.g., 35 seconds). This determination can be based on the timer set in 439, for example. In many implementations, the predetermined period is shorter than a conventional duration (e.g., one minute). As a result, some implementations can avoid a situation in which reliance is placed solely on the secondary PSAP, which might not be as responsive as a primary PSAP.

If the TCC determines that it received the secondary PSAP notification acknowledgement within the predetermined duration, then the signal flow advances to 448. On the other hand, if the TCC determines that it did not receive the secondary PSAP notification acknowledgement within the predetermined duration, then the signal flow advances to 451.

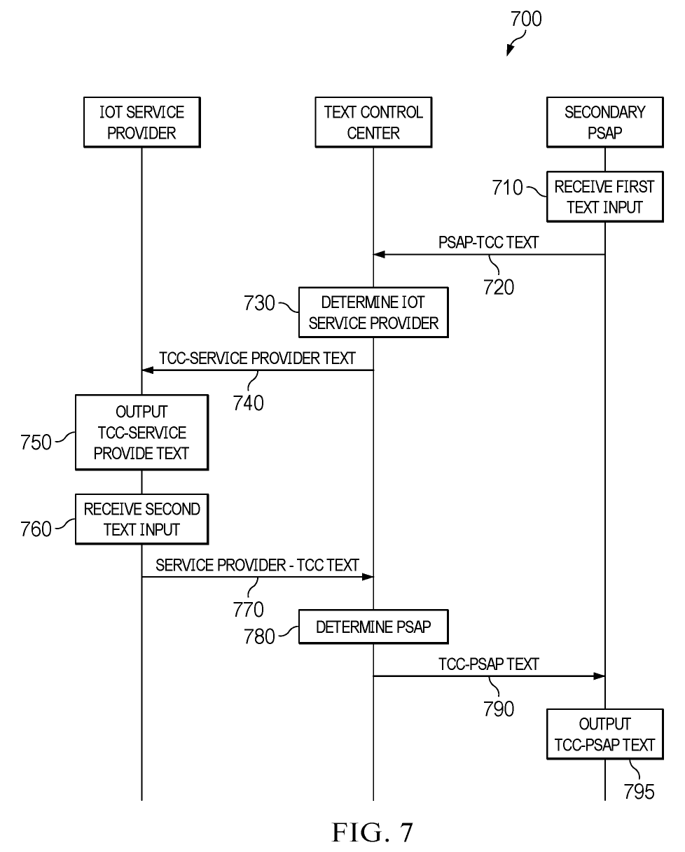

In 448, the TCC can send a TCC PSAP notification acknowledgement to an IoT911 gateway, which can then forward it to the service provider. The TCC PSAP notification acknowledgement can include data that can be used as a session identifier. Accordingly, at this point, the call taker in the PSAP and the operator at the IoT service provider can enter into a text conversation, as discussed in more detail in connection with FIG. 7.

Briefly returning to 445, if the secondary PSAP notification acknowledgement was not received, then the signal flow advances to 451. In 451, the TCC generates a primary PSAP notification. For example, the primary PSAP notification can include or indicate all or some of the information in the TCC text messaging request, such as the address and the CBN. The primary PSAP notification can indicate or include the primary PSAP ID. The signal flow then advances to 454.

In 454, the TCC can transmit the primary PSAP notification to the primary PSAP, which receives the primary PSAP notification. The TCC can also begin a timer. The signal flow then advances to 457.

If a workstation at the primary PSAP answers the call, the primary PSAP can transmit in 457 a primary PSAP notification acknowledgement to the IoT service provider. In some implementations, the primary PSAP can transmit the primary PSAP notification acknowledgement to the TCC, which can then relay it to the IoT service provider. The primary PSAP notification acknowledgement can indicate or include the alarm incident number, for example. The signal flow then advances to 460.

In 460, the IoT service provider determines whether an acknowledgement was received within a predetermined duration (e.g., 60 seconds). This determination can be based on the timer started in 421, for example. The acknowledgement can be the TCC PSAP notification acknowledgement or the primary PSAP notification acknowledgement, for example.

If the IoT service provider determines an acknowledgement was not received within the predetermined duration, then a call taker at the secondary PSAP or the primary PSAP might not be aware of the event. Accordingly, the signal flow advances to 463.

In 463, the IoT service provider instructs the agent at the IoT service provider to call the primary PSAP. For example, the IoT service provider can display a telephone number of the primary PSAP on a display to the agent. In some implementations, the IoT service provider can dial an outbound call to the primary PSAP on behalf of the agent. The agent can then inform the call taker at the primary PSAP of the event, such as via voice communication. The signal flow then advances to 469.

On the other hand, if the IoT service provider determines in 460 that an acknowledgement was received within the predetermined duration, then the signal flow advances to 466.

In 466, the IoT service provider can begin a texting session with the acknowledging PSAP via the TCC. The texting session is discussed in more detail in the context of FIG. 7. The signal flow then advances to 469.

In 469, the signal flow concludes.

Thus, in at least some implementations of the present disclosure, the IoT service provider can directly notify a secondary PSAP of an event, rather than first notifying a primary PSAP, which then transfers responsibility for the event to the secondary PSAP. Accordingly, call processing times and personnel dispatch times can be reduced.45

In addition, because a secondary PSAP might not be as responsive as a primary PSAP, the TCC can provide redundancy by contacting a primary PSAP after the expiration of a predetermined duration. Further, responsibility for contacting the primary PSAP is retained by the TCC upon the expiration of the predetermined duration. Thus, the TCC can contact the primary PSAP, rather than tasking the operator at the IoT service provider with contacting the secondary PSAP, which might not be responsive. Further, because the TCC can contact the primary PSAP, it is not necessary for the operator at the IoT service provider to contact the primary PSAP upon expiration of the shortened predetermined duration.

It is also possible the person monitoring the IoT device will call to confirm an emergency. Thus, the signal flow can advance from 418 to 421, if the IoT service provider indicates there is an emergency.

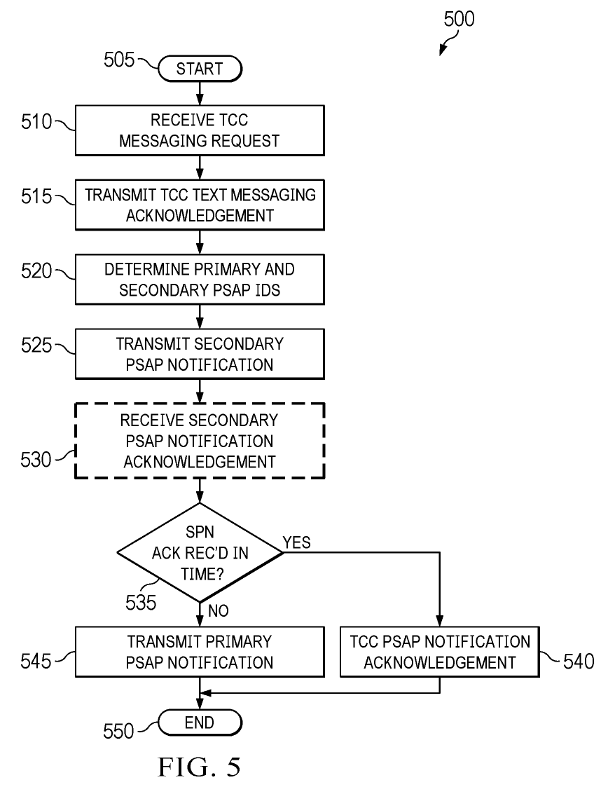

FIG. 5 illustrates an algorithm 500 for a TCC for communicating with a secondary PSAP, according to an implementation of the present disclosure. The algorithm 500 begins at 505 and advances to 510.

In 510, the TCC receives a TCC messaging request from the IoT service provider. The algorithm 500 then advances to 515.

In 515, the TCC transmits a TCC text messaging acknowledgement to the IoT service provider. The algorithm 500 then advances to 520.

In 520, the TCC produces the primary and secondary PSAP IDs. In particular, the TCC can produce the primary and secondary PSAP IDs by transmitting a PSAP ID request to an emergency services vendor. The PSAP ID request can include a position and an alarm type, for example. Accordingly, the emergency services vendor can determine the primary and secondary PSAP IDs and transmit the primary and secondary PSAP IDs to the TCC. The algorithm 500 then advances to 525.

In 525, the TCC transmits a secondary PSAP notification, at least in part based on the secondary PSAP ID. In addition, the TCC can start a timer. The algorithm 500 can then advance to 530.

In 530, the TCC optionally receives a secondary PSAP notification acknowledgement. The algorithm 500 then advances to 535.

In 525, the TCC can determine whether it received a secondary PSAP notification acknowledgement within a predetermined duration. The TCC can determine whether the predetermined duration has expired, at least in part based on the timer started in 525. If the TCC determines the secondary PSAP notification acknowledgement was received within the predetermined duration, the algorithm 500 advances to 540.

In 540, the TCC transmits a TCC PSAP notification acknowledgement to the IoT service provider. The algorithm 500 then advances to 550.

On the other hand, if the TCC determines the secondary PSAP notification acknowledgement was not received within the predetermined duration, the algorithm 500 advances to 545. In 545, the TCC transmits a primary PSAP notification, at least in part based on the primary PSAP ID. The algorithm then advances to 550.

In 550, the algorithm 500 concludes.

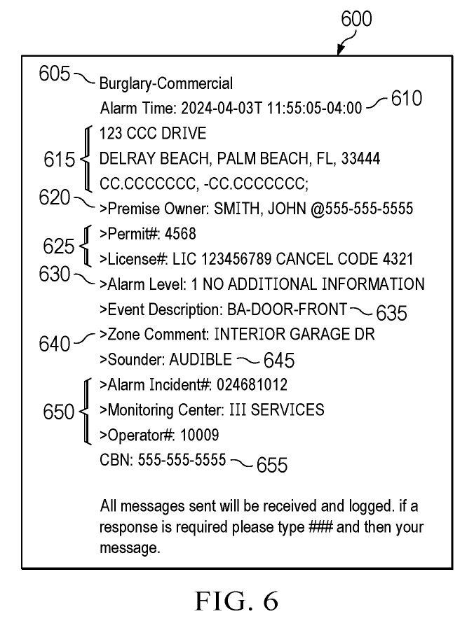

FIG. 6 illustrates an exemplary screenshot 600 of a display at a primary or secondary PSAP, according to an implementation of the present disclosure. The screenshot includes a plurality of fields 605, 610, 615, 620, 625, 630, 635, 640, 645, 650, and 655.

Field 605 indicates an alarm type. The alarm type can include an event type (e.g., burglary, tamper, duress, hold up, fire, or medical), as well as an address type (e.g., commercial, residential, or industrial).

Field 610 indicates a time and date of an alarm in a time local to the PSAPs. In some implementations, the time is displayed in National Emergency Number Association (NENA) format.

Field 615 indicates location information. The location information can include a civic (e.g., dispatchable) address. In field 615 illustrated in FIG. 6, the location information also includes geographic coordinates. In some implementations, the location information can additionally or alternatively include data compliant with what3words.

Field 620 indicates a name of a client of the IoT service provider and a contact telephone number for that client. In some implementations, the name can be the name of a beneficiary. In some implementations, the name can be the name of a person responsible for monitoring the IoT device.

Field 625 indicates compliance information, such as a permit number, a license number, and/or a substation ID. The compliance information can additionally or alternatively include a code for the IoT device. In many implementations, field 625 is optional.

Field 630 indicates an alarm level. In many implementations, this information is acquired by the IoT service provider speaking to the client.

In various implementations, the alarm level complies with the Alarm Validation Scoring (AVS) standard set by the American National Standards Institute (ANSI) and The Monitoring Association (TMA) as ANSI/TMA-AVS-01. For example, in ANSI/TMA-AVS-01 dictates that Alarm Level 0 indicates no call for service, and Alarm Level 1 indicates a call for service with limited to no additional information.

Alarm Level 2 indicates a call for service with a confirmed or “highly probable” human presence with an unknown intent. For example, there might be a person on the premises of the IoT device or property damage.

Alarm Level 3 indicates a call for service with a confirmed threat to property. For example, there might be a person on the premises and property damage.

Alarm Level 4 indicates a call for service with a confirmed threat to life.

Field 635 indicates an event description. The event description can be, include, or indicate additional information related to the alarm. For example, the event description might indicate a entry into a commercial building triggered a burglar alarm at the front door of the building.

Field 640 indicates zone information that provides a specific location of the IoT device that triggered (e.g., northeast window or interior garage door).

Field 645 indicates whether the IoT device is emitting an audible or silent alarm.

Field 650 indicates monitoring information for reference when interacting with the IoT service provider. The monitoring information can include an alarm incident number, a monitoring center, and an operator number, for example. Thus, for example, a call taker at the PSAP can use the monitoring information during a call back to the IoT service provider to receive additional information. Similarly, the PSAP can transmit the alarm incident number, an identifier of the monitoring center, and/or the operator number in text conversations with the IoT service provider, as discussed below in connection with FIG. 7. The monitoring information can additionally include a session number for these purposes, as well.

Field 655 indicates a callback number for the IoT service provider. Thus, the call taker can make a voice call back to the IoT service provider for further information by using the callback number. The callback number can direct a call to a call center at the IoT service provider or to specifically the responsible operator, in various implementations.

In the above discussion, the text control center retrieves the location information from the emergency services vendor and forwards the location information. In some implementations, the PSAP itself can retrieve the location information via HTTP-Enabled Location Delivery (HELD). In many implementations, the Secondary or Primary PSAP notification includes the position, such that the PSAP can retrieve the location information based on the position. Further, in various implementations, the PSAP can retrieve additional data from an additional data repository (ADR). An ADR is a database that includes information about a call, caller, and/or location.

Turning to FIG. 7, after the secondary PSAP acknowledges the text in 442, the TCC can coordinate a texting session between that PSAP and the IOT vendor. FIG. 7 illustrates an algorithm 700 for communicating messages between an IoT service provider and a secondary PSAP via a text control center, according to an implementation of the present disclosure.

The algorithm 700 begins at 710, at which the secondary PSAP receives a first text input from the calltaker. In many implementations, the secondary PSAP can receive the first text input via a keyboard, for example. In other implementations, the secondary PSAP can receive a voice input from the calltaker via a microphone and perform speech recognition on the voice input to produce the first text input. In select implementations, the secondary PSAP can receive the first text input via a touchscreen or other virtual keyboard operated by a mouse, for example. The algorithm 700 then advances to 720.

In 720, the secondary PSAP transmits a PSAP-TCC text to the TCC. The PSAP-TCC text can include or indicate the first text input. Further, the PSAP-TCC text can include or indicate the monitoring information, such as an alarm incident number, a monitoring center, an operator number, and/or a session number. In several implementations, the first text input can include or indicate predetermined characters, such as a tag like “##.” In various implementations, the first text input can begin or end with the predetermined characters. The algorithm 700 then advances to 730.

In 730, the TCC determines the IoT service provider, at least in part based on the alarm incident number, the monitoring center, the operator number, and/or the session number included in the PSAP-TCC text. The algorithm 700 then advances to 740.

In 740, the TCC transmits a TCC-service provider text to the IoT service provider determined in 730. The TCC-service provider text can include or indicate the first text input, as well as the alarm incident number, the monitoring center, the operator number, and/or the session number. The TCC can also format the first text input in a different manner in the TCC-service provider text. The TCC can move the predetermined characters from the end of the first text input to the beginning of the first text input, for example. In some implementations, the TCC can reduce the first text input to fewer than 140 characters, such that the TCC breaks a first text input exceeding 140 characters into two or more TCC-service provider texts. The algorithm 700 then advances to 750.

In 750, the IoT service provider outputs the TCC-service provider text to an operator at the call center. In many implementations, this output occurs via a display at the call center. In some implementations, a computer at the call center can perform text-to-speech synthesis on the first text input to produce a voice output and output the voice output via a headset, headphones, and/or a speaker.

The operator at the IoT service provider can understand that predetermined characters, such as a prefix of ##, indicates that an immediate response should be sent.

The algorithm 700 then advances to 760.

In 760, the IoT service provider receives a second text input. In many implementations, the IoT service provider can receive the second text input via a keyboard, for example. In other implementations, the IoT service provider can receive a voice input from the operator via a microphone and perform speech recognition on the voice input to produce the second text input. In select implementations, the IoT service provider can receive the second text input via a touchscreen or other virtual keyboard operated by a mouse, for example. The algorithm 700 then advances to 770.

In 770, the IoT service provider transmits a service provider-TCC text to the TCC. The service provider-TCC text can include or indicate the second text input. Further, the service provider-TCC text can include or indicate the monitoring information, such as the alarm incident number, the monitoring center, the operator number, and/or the session number. The algorithm 700 then advances to 780.

In 780, the TCC determines the PSAP, at least in part based on the alarm incident number, the monitoring center, the operator number, and/or the session number. The algorithm 700 then advances to 790.

In 790, the TCC transmits a TCC-PSAP text to the PSAP determined in 780. The TCC-PSAP text can include or indicate the second text input, as well as the alarm incident number, the monitoring center, the operator number, and/or the session number. The TCC can also format the second text input in a different manner in the TCC-PSAP text. For example, in some implementations, the TCC can reduce the second text input to fewer than 140 characters, such that the TCC breaks a second text input exceeding 140 characters into two or more TCC-PSAP texts.

In 795, the secondary PSAP outputs the TCC-PSAP text to a calltaker at the PSAP. In many implementations, this output occurs via a display at the PSAP. In some implementations, a computer at the PSAP can perform text-to-speech synthesis on the second text input to produce a voice output and output the voice output via a headset, headphones, and/or a speaker.

The algorithm 700 can then iterate or conclude.

Once a call taker at a PSAP has finished handling the event, they can release the event (e.g., the messaging session). The PSAP can then send a message with an end indicator (e.g., a “bye” flag) to the IoT service provider via the IoT911 gateway, for example.

If the operator at the PSAP intends to contact the IoT service provider (e.g., to receive additional information in view of changed circumstances), then the operator can dial the callback number.

On the other hand, if the IoT service provider attempts to send a text message after the PSAP has terminated the call, the IoT911 gateway can respond with an error. In this case, the IoT service provider can create a new event.

Thus, select implementations of the present disclosure can reduce the time for a secondary PSAP to process a call, such as from an IoT service provider. Consequently, some such implementations can also reduce dispatch times by the secondary PSAP. Further, because the processing can bypass primary PSAPs, the processing load of primary PSAPs can also be reduced. Accordingly, processing and dispatch times from a primary PSAP can also be reduced. Various implementations can therefore encourage secondary PSAPs, particularly those dispatching fire and/or emergency medical services (EMS), to participate in implementations.

A “communication” includes any exchange originating from one point and received by another point using a telephone system. Examples of telephone systems include the Plain Old Telephone Service (POTS), Integrated Services Digital Network (ISDN) Basic Rate Interface (BRI), cellular telephone systems, and VoIP. The communication can be carried by any type of medium, such as wired, wireless, satellite, infrared, Bluetooth™, Virtual Private Network (VPN), or a proprietary link.

Further, this communication can be between devices (such as a telephone, cellular telephone, computer, or Internet of Things (IoT) device), between devices and communication platforms, between one or more proprietary devices, and/or between one more elements that leverage artificial intelligence (AI) and/or are powered by machine learning (ML). Communication platforms can include a mobile phone app, such as Facebook Messenger, WhatsApp, LINE, Signal, or Telegram. Further, any type of proxy can be implicated in such communication scenarios (i.e., a communication made on behalf of a device, a system, etc.).

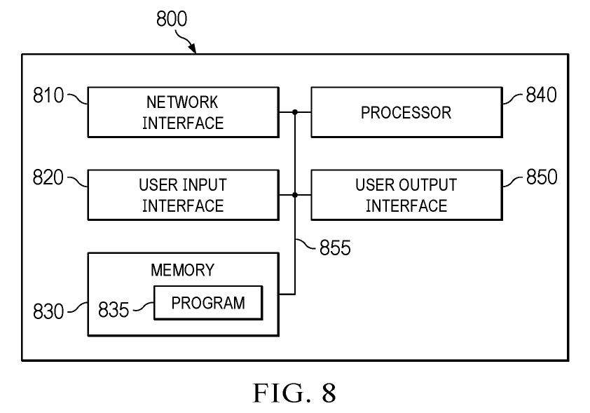

FIG. 8 illustrates a computing device 800, according to an implementation of the present disclosure. Any combination of wireless network 110, TCC 120, IoT service provider 130, emergency services vendor 140, session border controller 150, router 160, or PSAP 170 can be implemented by a computing device 800.

The computing device 800 can include a network interface 810, a user input interface 820, a memory 830, a program 835, a processor 840, a user output interface 850, and a bus 855.

Although illustrated within a single housing, the computing device 800 can be distributed across plural housings or sub-systems that cooperate in executing program instructions. In some implementations, the computing device 800 can include one or more blade server devices, standalone server devices, personal computers (including desktop computers, laptop computers, and tablet computers), routers, hubs, switches, bridges, firewall devices, intrusion detection devices, mainframe computers, network-attached storage devices, smartphones and other mobile telephones, and other computing devices. Although the computing device executes the Windows OS, macOS, or Linux in many implementations, the hardware can be configured according to a Symmetric Multi-Processing (SMP) architecture or a Non-Uniform Memory Access (NUMA) architecture.

The network interface 810 provides one or more communication connections and/or one or more devices that allow for communication between the computing device 800 and other computing systems (not shown) over a communication network, collection of networks (not shown), or the air, to support the text control center for a secondary PSAP, outlined herein. The network interface 810 can communicate using various networks (including both internal and external networks) such as near-field communications (NFC), Wi-Fi^{TM}, Bluetooth, Ethernet, cellular (e.g., 3G, 4G, 5G), white space, 802.11x, satellite, LTE, GSM/HSPA, CDMA/EVDO, DSRC, CAN, GPS, facsimile, or any other wired or wireless interface. Other interfaces can include physical ports (e.g., Ethernet, USB, HDMI, etc.), interfaces for wired and wireless internal subsystems, and the like. Similarly, nodes and user equipment (e.g., mobile devices) of the system can also include suitable interfaces for receiving, transmitting, and/or otherwise communicating data or information in a network environment.

The user input interface 820 can receive one or more inputs from a human. The user input interface 820 can be or include a mouse, a touchpad, a keyboard, a touchscreen, a trackball, a camera, a microphone, a joystick, a game controller, a scanner, and/or any other input device.

The memory 830, also termed a “storage,” can include or be one or more computer-readable storage media readable by the processor 840 and that store software. The memory 830 can be implemented as one storage device or across multiple co-located or distributed storage devices or sub-systems. The memory 830 can include additional elements, such as a controller, that communicate with the processor 840. The memory 830 can also include storage devices and/or sub-systems on which data and/or instructions are stored. The computing device 800 can access one or more storage resources to access information to carry out any of the processes indicated in this disclosure and, in particular, FIGS. 4A-4B, 5, and 7. In various implementations, the memory 830 stores the program 835 to execute at least a portion of the algorithms illustrated in FIGS. 4A-4B, 5, and 7. Further, the program 835, when executed by the computing device 800 generally and/or the processor 840 specifically, can direct, among other functions, performance of the operations of a text control center for a secondary PSAP, as described herein.

The memory 830 can be or include a read-only memory (ROM), a programmable ROM (PROM), an erasable PROM (EPROM), an electrically erasable PROM (EEPROM), a random-access memory (RAM), a dynamic RAM (DRAM), a static RAM (SRAM), a field programmable gate array (FPGA), a hard drive, a cache memory, a flash memory, a removable disk, or a tape reel. The memory 830 can be or include resistive RAM (RRAM) or a magneto-resistive RAM (MRAM). The information being tracked, sent, received, or stored in the communication system can be provided in any database, register, table, cache, queue, control list, or storage structure, based on particular implementations, all of which could be referenced in any suitable timeframe.

The processor 840 (e.g., a processing unit) can be or include one or more hardware processors and/or other circuitry that retrieve and execute software, especially the program 835, from the memory 830. The processor 840 can be implemented within one processing device, chip, or package and can also be distributed across multiple processing devices, chips, packages, or sub-systems that cooperate. In some implementations, the processor 840 is or includes a Graphics Processing Unit (GPU) or neural processing unit (NPU).

The processor 840 can have any register size, such as a 32-bit register or a 64-bit register, among others. The processor 840 can include multiple cores. Implementations of the processor 840 are not limited to any particular number of threads. The processor 840 can be fabricated by any process technology, such as 14nm process technology.

The user output interface 850 outputs information to a human user. The user output interface 850 can be or include a display (e.g., a screen), a touchscreen, speakers, a printer, or a haptic feedback unit. In many implementations, the user output interface 850 can be combined with the user input interface 820. For example, some such implementations include a touchscreen, a headset including headphones and a microphone, or a joystick with haptic feedback.

In implementations including multiple computing devices, a server of the system or, in a serverless implementation, a peer can use one or more communications networks that facilitate communication among the computing devices to achieve the text control center for a secondary PSAP, as outlined herein. For example, the one or more communications networks can include or be a local area network (LAN) or wide area network (WAN) that facilitate communication among the computing devices. One or more direct communication links can be included between the computing devices. In addition, in some cases, the computing devices can be installed at geographically distributed locations. In other cases, the multiple computing devices can be installed at one geographic location, such as a server farm or an office.

As used herein, the terms “storage media” or “computer-readable storage media” can refer to non-transitory storage media, such as non-limiting examples of a hard drive, a memory chip, an ASIC, and cache memory, and to transitory storage media, such as carrier waves, propagating signals, or software per se.

Aspects of the system can be implemented in various manners, e.g., as a method, a system, a computer program product, or one or more computer-readable storage media. Accordingly, aspects of the present disclosure can take the form of a hardware implementation, a software implementation (including firmware, resident software, or micro-code) or an implementation combining software and hardware aspects that can generally be referred to herein as a “module” or a “system.” Functions described in this disclosure can be implemented as an algorithm executed by one or more hardware processing units, e.g., the processor 840. In various embodiments, different operations and portions of the operations of the algorithms described can be performed by different processing units. In some implementations, the operations can be achieved by reciprocating software in any of the wireless network 110, TCC 120, IoT service provider 130, emergency services vendor 140, session border controller 150, router 160, or PSAP 170 can be implemented by a computing device 800. The program 835 can be implemented using reciprocating software across multiple devices. Furthermore, aspects of the present disclosure can take the form of a computer program product embodied in one or more computer-readable media having computer-readable program code embodied, e.g., encoded or stored, thereon. In various implementations, such a computer program can, for example, be downloaded (or updated) to existing devices and systems or be stored upon manufacture of these devices and systems.

Any suitable permutation can be applied to a physical implementation, including the design of the communications network in which the system is implemented. In one embodiment, the bus 855 can share hardware resources with the memory 830 and the processor 840. In this alternative implementation, the computing device 800 can be provided with separate hardware resources including one or more processors and memory elements.

In example implementations, various other components of the computing device 800 can be installed in different physical areas or can be installed as single units.

The communication system can be configured to facilitate communication with machine devices (e.g., alarms, vehicle sensors, instruments, electronic control units (ECUs), embedded devices, actuators, displays, etc.) through the bus 855. Other suitable communication interfaces can also be provided for an Internet Protocol (IP) network, a user datagram protocol (UDP) network, or any other suitable protocol or communication architecture enabling network communication with machine devices.

The innovations in this detailed description can be implemented in a multitude of different ways, for example, as defined and covered by the claims and/or select examples. In the description, reference is made to the drawings where like reference numerals can indicate identical or functionally similar elements. Elements illustrated in the drawings are not necessarily drawn to scale. Additionally, certain implementations can include more elements than illustrated in a drawing and/or a subset of the elements illustrated in a drawing. Further, some implementations can incorporate a suitable combination of features from two or more drawings.

The disclosure describes various illustrative implementations and examples for implementing the features and functionality of the present disclosure. The components, arrangements, and/or features are described in connection with various implementations and are merely examples to simplify the present disclosure and are not intended to be limiting. In the development of actual implementations, implementation-specific decisions can be made to achieve specific goals, including compliance with system, business, and/or legal constraints, which can vary from one implementation to another. Additionally, while such a development effort might be complex and time-consuming, it would be a routine undertaking for those of ordinary skill in the art having the benefit of this disclosure.

The systems, methods and devices of this disclosure have several innovative aspects, no one of which is solely responsible for the attributes disclosed herein. Some objects or advantages might not be achieved by implementations described herein. Thus, for example, certain implementations can operate in a manner that achieves or optimizes one advantage or group of advantages as taught herein and not other objects or advantages as taught or suggested herein.

In one example implementation, electrical circuits of the drawings can be implemented on a board of an associated electronic device. The board can be a general circuit board that can hold various components of the internal electronic system of the electronic device and, further, provide connectors for other peripherals. More specifically, the board can provide the electrical connections by which other components of the system can communicate electrically. Any processors (inclusive of digital signal processors, microprocessors, supporting chipsets, etc.) and computer-readable, non-transitory memory elements can be coupled to the board based on configurations, processing demands, and computer designs. Other components such as external storage, additional sensors, controllers for audio/video display, and peripheral devices can be attached to the board as plug-in cards, via cables, or integrated into the board itself. In various implementations, the functionalities described herein can be implemented in emulation form as software or firmware running within one or more configurable (e.g., programmable) elements arranged in a structure that supports these functions. A non-transitory, computer-readable storage medium can include instructions to allow one or more processors to carry out the emulation.

In another example implementation, the electrical circuits of the drawings can be implemented as stand-alone modules (e.g., a device with associated components and circuitry configured to perform a specific application or function) or implemented as plug-in modules into application specific hardware of electronic devices. Implementations of the present disclosure can be readily included in a system-on-chip (SOC) package. An SOC represents an integrated circuit (IC) that integrates components of a computer or other electronic system into one chip. The SOC can contain digital, analog, mixed-signal, and often radio frequency functions on one chip substrate. Other implementations can include a multi-chip-module (MCM), with a plurality of separate ICs located within one electronic package and that interact through the electronic package. In various other implementations, the processors can be implemented in one or more silicon cores in Application Specific Integrated Circuits (ASICs), Field Programmable Gate Arrays (FPGAs), programmable array logic (PAL), generic array logic (GAL), and other semiconductor chips.

The specifications, dimensions, and relationships outlined herein (e.g., the number of processors and logic operations) have been offered for non-limiting purposes of example and teaching. For example, various modifications and changes can be made to the arrangements of components. The description and drawings are, accordingly, to be regarded in an illustrative sense, not in a restrictive sense.

The numerous examples provided herein described interaction in terms of two, three, or more electrical components for purposes of clarity and example. The system can be consolidated in any manner. Along similar design alternatives, the illustrated components, modules, and elements of the drawings can be combined in various possible configurations within the scope of this disclosure. In certain cases, one or more of the functionalities of a given set of flows might be more clearly described by referencing a limited number of electrical elements. The electrical circuits of the drawings are readily scalable and can accommodate many components, as well as more complicated/sophisticated arrangements and configurations. Accordingly, the provided examples do not limit the scope or inhibit the teachings of the electrical circuits as potentially applied to a myriad of other architectures.

In this disclosure, references to various features (e.g., elements, structures, modules, components, steps, operations, characteristics, etc.) included in “one implementation,” “example implementation,” “an implementation,” “another implementation,” “some implementations,” “various implementations,” “other implementations,” “alternative implementation,” and the like are intended to mean that any such features can be included in one or more implementations of the present disclosure and might or might not necessarily be combined in the same implementations. Some operations can be deleted or omitted where appropriate, or these operations can be modified or changed considerably. In addition, the timing of these operations can be altered considerably. The preceding operational flows have been offered for purposes of example and discussion. Implementations described herein provide flexibility in that any suitable arrangements, chronologies, configurations, and timing mechanisms can be provided.

### Examples

In Example M1, a method includes receiving a text control center (TCC) messaging request indicating a position of an alarm; determining a secondary PSAP ID, at least in part based on the position of the alarm; and transmitting a secondary PSAP notification, at least in part based on the secondary PSAP ID, the secondary PSAP notification indicating the position of the alarm.

Example M2 is the method of Example M1, further comprising: determining a primary PSAP ID, at least in part based on the position of the alarm; and transmitting a primary PSAP notification, at least in part based on the primary PSAP ID, the primary PSAP notification indicating the position of the alarm.

Example M3 is the method of Example M2, further comprising: determining that a secondary PSAP notification acknowledgement was not received within a predetermined duration.

Example M4 is the method of any of Examples M1-M3, wherein the TCC messaging request indicates an alarm type, and the secondary PSAP ID is obtained, at least in part based on the alarm type.

Example M5 is the method of any of Examples M1-M4, further comprising: receiving a secondary PSAP notification acknowledgement; and transmitting a TCC PSAP notification acknowledgement, at least in part based on a vendor ID, wherein the TCC notification indicates the vendor ID.

Example M6 is the method of any of Examples M1-M5, wherein the secondary PSAP notification indicates a vendor ID and a callback number of the vendor ID.

Example M7 is the method of any of Examples M1-M6, further comprising: receiving a text message from the secondary PSAP, the text message indicating monitoring information, the secondary PSAP notification indicating the monitoring information, and the TCC messaging request indicating the monitoring information; and transmitting at least a portion of the text message, at least in part based on the monitoring information.

In Example A1, a system includes at least one network interface that receives a text control center (TCC) messaging request indicating a position of an alarm; and at least one processor configured to cause the system to at least determine a secondary PSAP ID, at least in part based on the position of the alarm, wherein the at least one network interface transmits a secondary PSAP notification, at least in part based on the secondary PSAP ID, the secondary PSAP notification indicating the position of the alarm.

Example A2 is the system of Example A1, wherein the at least one processor is further configured to determine a primary PSAP ID, at least in part based on the position of the alarm, and the at least one network interface transmits a primary PSAP notification, at least in part based on the primary PSAP ID, the primary PSAP notification indicating the position of the alarm.

Example A3 is the system of Example A2, wherein the at least one processor is further configured to determine that a secondary PSAP notification acknowledgement was not received within a predetermined duration.

Example A4 is the system of any of Examples A1-A3, wherein the TCC messaging request indicates an alarm type, and the secondary PSAP ID is obtained, at least in part based on the alarm type.

Example A5 is the system of any of Examples A1-A4, wherein the at least one network interface receives a secondary PSAP notification acknowledgement, the at least one network interface transmits a TCC PSAP notification acknowledgement, at least in part based on a vendor ID, and the TCC notification indicates the vendor ID.

Example A6 is the system of any of Examples A1-A5, wherein the secondary PSAP notification indicates a vendor ID and a callback number of the vendor ID.

Example A7 is the system of any of Examples A1-A6, wherein the at least one network interface receives a text message from the secondary PSAP, the text message indicating monitoring information, the secondary PSAP notification indicating the monitoring information, the TCC messaging request indicating the monitoring information, and the at least one network interface transmits at least a portion of the text message, at least in part based on the monitoring information.

In Example C1, a computer-readable medium is encoded with a computer program that, when executed by a system including at least one processor, causes the system to perform operations. The operations include receiving a text control center (TCC) messaging request indicating a position of an alarm; determining a secondary PSAP ID, at least in part based on the position of the alarm; and transmitting a secondary PSAP notification, at least in part based on the secondary PSAP ID, the secondary PSAP notification indicating the position of the alarm.

Example C2 is the medium of Example C1, the operations further comprising: determining a primary PSAP ID, at least in part based on the position of the alarm; and transmitting a primary PSAP notification, at least in part based on the primary PSAP ID, the primary PSAP notification indicating the position of the alarm.

Example C3 is the medium of Example C2, the operations further comprising: determining that a secondary PSAP notification acknowledgement was not received within a predetermined duration.

Example C4 is the medium of any of Examples C1-C3, wherein the TCC messaging request indicates an alarm type, and the secondary PSAP ID is obtained, at least in part based on the alarm type.

Example C5 is the medium of any of Examples C1-C4, the operations further comprising: receiving a secondary PSAP notification acknowledgement; and transmitting a TCC PSAP notification acknowledgement, at least in part based on a vendor ID, wherein the TCC notification indicates the vendor ID.

Example C6 is the medium of any of Examples C1-C5, wherein the secondary PSAP notification indicates a vendor ID and a callback number of the vendor ID.

Example C7 is the medium of any of Examples C1-C6, the operations further comprising: receiving a text message from the secondary PSAP, the text message indicating monitoring information, the secondary PSAP notification indicating the monitoring information, the TCC messaging request indicating the monitoring information; and transmitting at least a portion of the text message, at least in part based on the monitoring information.

In Example F1, a system includes communication means for receiving a text control center (TCC) messaging request indicating a position of an alarm; and processing means for determining a secondary PSAP ID, at least in part based on the position of the alarm, wherein the communication means transmit a secondary PSAP notification, at least in part based on the secondary PSAP ID, the secondary PSAP notification indicating the position of the alarm.

Example F2 is the system of Example F1, wherein the processing means determine a primary PSAP ID, at least in part based on the position of the alarm, and the communication means transmit a primary PSAP notification, at least in part based on the primary PSAP ID, the primary PSAP notification indicating the position of the alarm.

Example F3 is the system of Example F2, wherein the processing means determine that a secondary PSAP notification acknowledgement was not received within a predetermined duration.

Example F4 is the system of any of Examples F1-F3, wherein the TCC messaging request indicates an alarm type, and the secondary PSAP ID is obtained, at least in part based on the alarm type.

Example F5 is the system of any of Examples F1-F4, wherein the communication means receive a secondary PSAP notification acknowledgement, the communication means transmit a TCC PSAP notification acknowledgement, at least in part based on a vendor ID, and the TCC notification indicates the vendor ID.

Example F6 is the system of any of Examples F1-F5, wherein the secondary PSAP notification indicates a vendor ID and a callback number of the vendor ID.

Example F7 is the system of any of Examples F1-F6, wherein the communication means receive a text message from the secondary PSAP, the text message indicating monitoring information, the secondary PSAP notification indicating the monitoring information, and the TCC messaging request indicating the monitoring information, and the communication means transmit at least a portion of the text message, at least in part based on the monitoring information.

We claim:

1. A method, comprising:
receiving a text control center (TCC) messaging request indicating a position of an alarm;
determining a secondary PSAP ID, at least in part based on the position of the alarm; and
transmitting a secondary PSAP notification, at least in part based on the secondary PSAP ID, the secondary PSAP notification indicating the position of the alarm.

2. The method of claim 1, further comprising:
determining a primary PSAP ID, at least in part based on the position of the alarm; and
transmitting a primary PSAP notification, at least in part based on the primary PSAP ID, the primary PSAP notification indicating the position of the alarm.

3. The method of claim 2, further comprising:
determining that a secondary PSAP notification acknowledgement was not received within a predetermined duration.

4. The method of claim 1, wherein the TCC messaging request indicates an alarm type, and the secondary PSAP ID is obtained, at least in part based on the alarm type.

5. The method of claim 1, further comprising:
receiving a secondary PSAP notification acknowledgement; and
transmitting a TCC PSAP notification acknowledgement, at least in part based on a vendor ID, wherein the TCC notification indicates the vendor ID.

6. The method of claim 1, wherein the secondary PSAP notification indicates a vendor ID and a callback number of the vendor ID.

7. The method of claim 1, further comprising:
receiving a text message from the secondary PSAP, the text message indicating monitoring information, the secondary PSAP notification indicating the monitoring information, and the TCC messaging request indicating the monitoring information; and
transmitting at least a portion of the text message, at least in part based on the monitoring information.

8. A system, comprising:
at least one network interface that receives a text control center (TCC) messaging request indicating a position of an alarm; and
at least one processor configured to cause the system to at least determine a secondary PSAP ID, at least in part based on the position of the alarm, wherein
the at least one network interface transmits a secondary PSAP notification, at least in part based on the secondary PSAP ID, the secondary PSAP notification indicating the position of the alarm.

9. The system of claim 8, wherein
the at least one processor is further configured to determine a primary PSAP ID, at least in part based on the position of the alarm, and
the at least one network interface transmits a primary PSAP notification, at least in part based on the primary PSAP ID, the primary PSAP notification indicating the position of the alarm.

10. The system of claim 9, wherein the at least one processor is further configured to determine that a secondary PSAP notification acknowledgement was not received within a predetermined duration.

11. The system of claim 8, wherein the TCC messaging request indicates an alarm type, and the secondary PSAP ID is obtained, at least in part based on the alarm type.

12. The system of claim 8, wherein
the at least one network interface receives a secondary PSAP notification acknowledgement,
the at least one network interface transmits a TCC PSAP notification acknowledgement, at least in part based on a vendor ID, and the TCC notification indicates the vendor ID.

13. The system of claim 8, wherein the secondary PSAP notification indicates a vendor ID and a callback number of the vendor ID.

14. The system of claim 8, wherein
the at least one network interface receives a text message from the secondary PSAP, the text message indicating monitoring information, the secondary PSAP notification indicating the monitoring information, the TCC messaging request indicating the monitoring information, and
the at least one network interface transmits at least a portion of the text message, at least in part based on the monitoring information.

15. A computer-readable medium encoded with a computer program that, when executed by a system including at least one processor, causes the system to perform operations comprising:
receiving a text control center (TCC) messaging request indicating a position of an alarm;
determining a secondary PSAP ID, at least in part based on the position of the alarm; and
transmitting a secondary PSAP notification, at least in part based on the secondary PSAP ID, the secondary PSAP notification indicating the position of the alarm.

16. The medium of claim 15, the operations further comprising:
determining a primary PSAP ID, at least in part based on the position of the alarm; and
transmitting a primary PSAP notification, at least in part based on the primary PSAP ID, the primary PSAP notification indicating the position of the alarm.

17. The medium of claim 16, the operations further comprising:
determining that a secondary PSAP notification acknowledgement was not received within a predetermined duration.

18. The medium of claim 15, wherein the TCC messaging request indicates an alarm type, and the secondary PSAP ID is obtained, at least in part based on the alarm type.

19. The medium of claim 15, wherein the secondary PSAP notification indicates a vendor ID and a callback number of the vendor ID.

20. The medium of claim 15, the operations further comprising:
receiving a text message from the secondary PSAP, the text message indicating monitoring information, the secondary PSAP notification indicating the monitoring information, the TCC messaging request indicating the monitoring information; and
transmitting at least a portion of the text message, at least in part based on the monitoring information.
